(19) United States
(12) Patent Application Publication
(10) Pub. No.: US 2012/0158756 A1
(43) Pub. Date: Jun. 21, 2012

(54) Searching in Peer to Peer Networks

(76) Inventors: Jaime Jiménez, Espoo (FI); Jani Hautakorpi, Masala (FI); Jouni Mäenpää, Nummela (FI)

(21) Appl. No.: 12/976,808

(22) Filed: Dec. 22, 2010

(30) Foreign Application Priority Data
Dec. 20, 2010 (SE) PCT/SE2010/051426

(51) Int. Cl. G06F 17/30

(52) U.S. Cl. 707/754; 707/E17.032; 707/E17.014

(57) ABSTRACT

Embodiments herein include a method and apparatus for searching a structured peer-to-peer (P2P) network. A requesting node obtains a search term and generates a Bloom filter using the search term. The Bloom filter is sent to a searching node, which compares the received Bloom filter with at least one further Bloom filter stored at a database accessible by the searching node. The further Bloom filter is associated a further node in the P2P network. In the event that the Bloom filter and the further Bloom filter match, the searching node sends towards the requesting node an identity of the further node. This allows the requesting node to query the further node for the required data.

### RELATED APPLICATIONS

This application claims priority to International Application No. PCT/SE2010/051426 filed Dec. 20, 2010 and incorporated by reference herein in its entirety.

### TECHNICAL FIELD

The present invention generally relates to the field of searching for data in a peer to peer network.

### BACKGROUND

Peer-to-peer (P2P) networks make use of the pooled resources of participating nodes including processing capabilities and communication bandwidth to facilitate a wide variety of services, including file sharing and VoIP telephony. In the absence of central servers, particular P2P services may make use of “overlay networks” to optimise resource location. An overlay network comprises nodes connected by virtual links representing paths extending across possibly many physical links in the underlying network (e.g. the Internet). Each node in the overlay network maintains a routing table containing a set of links to certain other nodes within the overlay network. Resource requests are passed between nodes until they arrive at a node which is responsible for that resource.

P2P networks can be implemented in many different scenarios. Examples of such scenarios include file sharing, voice over IP and so on. P2P networks may be either unstructured or structured. An unstructured P2P network does not have a particular pattern in its organization; instead, connections between different peer nodes in the P2P network are set rather randomly. On the other hand, structured P2P networks have connections between peer nodes that are determined using certain algorithms, and the resulting P2P networks have a more structured pattern. By far the most common type of structured P2P networks are the DHT (Distributed Hash Table) based networks, such as Chord (see R. Stoica et al., “Chord: A Scalable Peer-to-peer Lookup Service for Internet Applications,” Proceedings of the ACM SIGCOMM '01 Conference, San Diego, Calif., August 2001, pp. 149).

Distributed Hash Tables (DHT) provide an efficient means for mapping resource names (“keys”) to locations within an overlay network. DHT makes use of a hashing algorithm to map keys, e.g. song titles, SIP URIs, etc, to a finite value space, e.g. 128 bits. The hashing algorithm is chosen to ensure a relatively uniform spread of hash values across the value space. Thus, for example, the hashing of 100 song titles will likely result in 100 hash values that are relatively evenly spaced across the value space. The hash values are stored in a hash table with several pairs of values (key, value). Nodes within an overlay network are identified by usernames, which are themselves hashed into respective hash values. Each node then becomes responsible for a set of hash values within the value space which neighbour its own value. In practice, a node will store locations (e.g. IP addresses) from which resources, matching resource names which it “owns”, can be obtained. When a node in the overlay network receives a request for a resource, the node determines whether or not it owns the corresponding hash value. If so, it returns the location of the resource to the requester (via the overlay network). If it does not own the hash value, it inspects its routing table to identify that node within the table which has a hash value closest to the hash value of the request, and forwards the request to that node. The receiving node repeats the procedure, and so on until the request arrives at the node which does own the hash value corresponding to the request and which therefore knows the resource location.

Currently, Peer-to-peer Session Initiation Protocol (P2PSIP) is under development. P2PSIP is a combination of SIP (Session Initiation Protocol, see J. Rosenberg et al, “SIP: Session Initiation Protocol,” RFC 3261, Internet Engineering Task Force, June 2002) and a P2P network. The main property of P2PSIP is that there is no need to provide centralized servers, such as those used in IP Multimedia Subsystem (IMS), and so a P2PSIP network is more robust and adaptable to changes than a standard IMS network.

Resource Location and Discovery (RELOAD, see C. Jennings et al., “Resource location and discovery (RELOAD) base protocol”, Draft, Internet Engineering Task Force, November 2009) is an implementation of P2PSIP that uses Chord as a DHT algorithm. RELOAD networks are structured P2P networks. If a peer node wishes to obtain a resource from another peer node, a lookups is performed by comparing the key for the resource with keys stored in other peer nodes. If the key matches the content exactly then it will be possible to retrieve the content.

A problem with searching for resources as described above is that it is impossible to formulate a search when the resource key is not known. A peer node cannot look for a resource using a key that does not exactly match a key for the resource stored in another peer node. So, for example, if a peer node wants to look up email addresses (resources) for “John Smith”, then he would need to already know the email addresses for John Smith in order to obtain that data. The peer node could not formulate a search using, for example, the terms “John” or “Smith”, as the key for these terms would not match any of the resources stored at other peer nodes. This becomes a significant problem in scenarios in which the information that the searching peer node has about the content it is looking is incomplete or inaccurate.

### SUMMARY

A method and apparatus is provided that allows a peer node to formulate a search of a structured peer-to-peer network, even where full information about the data being searched for is not available.

According to a first aspect, there is provided a requesting node for use in a structured peer-to-peer (P2P) network. The requesting node is provided with a device for obtaining a search term. A processor is also provided for using the search term to generate a Bloom filter. A first transmitter is used to send the Bloom filter to a searching node, the Bloom filter being usable by the searching node to perform a search. A first receiver is provided for receiving from the searching node an identity of a further node in the P2P network. The further node has access to data identified by a further Bloom filter that corresponds to the Bloom filter. A second transmitter is also provided for sending to the further node a request for the data, in order that the requesting node can obtain the required data. The use of Bloom filters to search for data allows much more flexible searches to be formulated.

There are many ways in which the requesting node can obtain a search term, and many different types of devices that can be used. Optional examples of devices include a user input device for allowing a user to enter a search term, and a processor for generating the search term.

As an option, the first transmitter is arranged to send the Bloom filter to the searching node in a RELOAD request message.

According to a second aspect, there is provided a searching node for use in a structured P2P network. The searching node is provided with a receiver for receiving from a requesting node a message, the message comprising a Bloom filter generated from a search term. A database accessing function is also provided, which is used to query a database. The database stores at least one further Bloom filter, the further Bloom filter being associated with a further node in the P2P network. A processor for determining whether the received Bloom filter and the further Bloom filter match. If so, then a transmitter sends an identity of the further node towards the requesting node, in order that the requesting node can query the further node for the requested data.

As an option, the searching node further comprises a second receiver for receiving from the further peer node a Bloom filter, and the processor is arranged to populate the database with the Bloom filter associated with an identity of the further node from which the Bloom filter was received.

The transmitter is optionally arranged to forward the Bloom filter to a further searching node. This allows more searching nodes to look for data on behalf of the requesting node, and increases the chances that the requesting node obtains an identity of a further peer node that can provide the requested data.

In an optional embodiment, the Bloom filter is received from the searching node in a RELOAD request message.

According to a third aspect, there is provided a peer node for use in a structured P2P network. The peer node is provided with a computer readable medium in the form of a memory, the memory being used to store data. A processor is provided for generating a Bloom filter using at least part of the stored data. A transmitter is provided for sending the Bloom filter and an identity of the peer node to a searching node, in order for the searching node to use the Bloom filter and the identity of the node in a search for data.

According to a fourth aspect, there is provided a method of searching a structured P2P network. A requesting node obtains a search term and generates a Bloom filter using the search term. The Bloom filter is sent to a searching node, which compares the received Bloom filter with at least one further Bloom filter stored at a database accessible by the searching node. The further Bloom filter is associated a further node in the P2P network. In the event that the Bloom filter and the further Bloom filter match, the searching node sends towards the requesting node an identity of the further node.

As an option, the method further comprises, at the searching node, and before receiving the Bloom filter from the requesting node, receiving from the further node a further Bloom filter, the further Bloom filter having been generated using data accessible by the further node. The further Bloom filter received from the further node and an associated identity of the further node is stored in the database.

The method optionally comprises the searching node, after comparing the received Bloom filter with at least one further Bloom filter stored at a database, sending the request to a further searching node in order to improve the likelihood that the search will be successful.

In this case, the results of the comparison are optionally added to the request before sending the request to the further searching node, so that when a reply is eventually sent back to the requesting node it contains the results of the comparisons made by all of the searching nodes.

The Bloom filter is optionally sent to the searching node in a RELOAD request message.

According to a fifth aspect, there is provided a computer program comprising computer readable code means which, when run on a requesting node causes the requesting node to behave as described above in the first aspect.

According to a sixth aspect, there is provided a computer program comprising computer readable code means which, when run on a searching node, causes the searching node to behave as described above in the second aspect.

According to a seventh aspect, there is provided a computer program, comprising computer readable code means which, when run on a peer node, causes the peer node to behave as described above in the third aspect.

According to an eighth aspect, there is provided a computer program product comprising a computer readable medium and a computer program as described above in any of the fifth, sixth or seventh aspects, wherein the computer program is stored on the computer readable medium.

### BRIEF DESCRIPTION OF THE DRAWINGS

FIG. 1 illustrates schematically in a block diagram a peer to peer network and signalling according to an embodiment of the invention;

FIG. 2 illustrates schematically in a block diagram a message structure according to an embodiment of the invention;

FIG. 3 is a signalling diagram illustrating the signalling required for a search according to an embodiment of the invention;

FIG. 4 illustrates schematically in a block diagram a peer node according to an embodiment of the invention; and

FIG. 5 illustrates schematically in a block diagram a search facilitator node according to an embodiment of the invention; and

FIG. 6 illustrates schematically in a block diagram a node according to an embodiment of the invention for use in a peer to peer network.

### DETAILED DESCRIPTION

Searching a P2P network using DHTs has heretofore required exact knowledge of the resource (or an identity of the resource) that a peer node is searching for. Embodiments herein perform more flexible and less restrictive searches using a Bloom filter.

A Bloom filter is a space-efficient probabilistic data structure used to test whether an element is a member of a set. False positives are possible, but false negatives are not. The probability of having false positives increases with the number of elements. An empty Bloom filter is an array of bits, all set to have a value of 0. To add an element to a bloom filter, a hash function is applied. For example, if data relating to a resource is added then a hash function is applied to the data and the results are interpreted as array positions in the Bloom filter. Those array positions within the Bloom filter are then set to a value of 1. More elements can be added, and this can lead to collisions with values being set to 1 for more than 1 element. A Bloom filter can therefore lead to a false positive in the event that elements give rise to the same 1 values in the array, and the more elements that are added to the Bloom filter, the greater the likelihood of a false positive being returned when querying the Bloom filter. However, it will be apparent that the Bloom filter can not return a false negative value as bits in the array are only set to 1 if an element is entered into the Bloom filter.

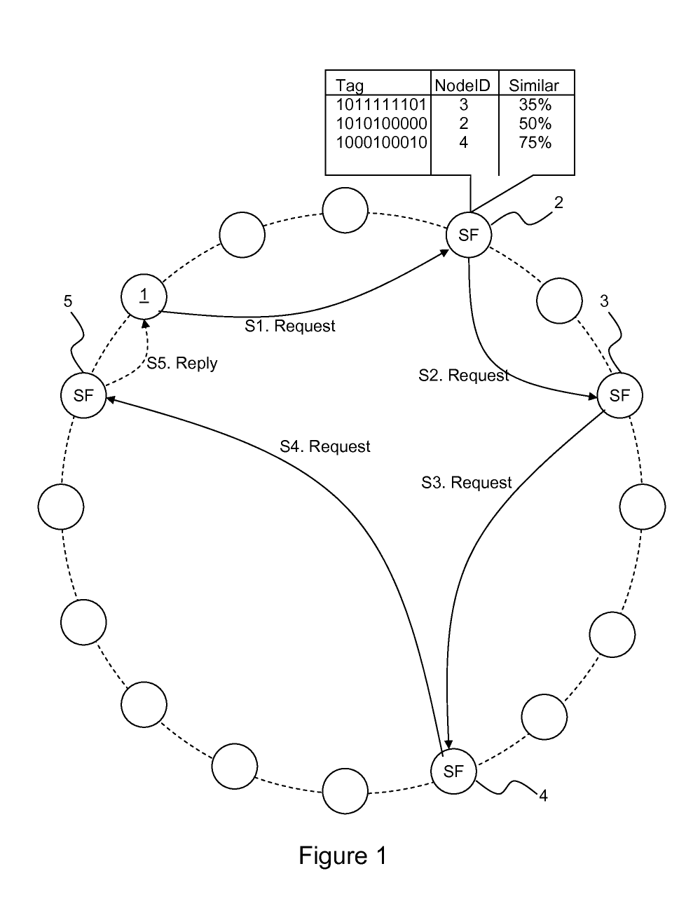

Referring to FIG. 1 herein, a network comprises a plurality of peer nodes (denoted by circles). In this example, a peer node 1 wishes to search the network for a resource. The network further comprises one or more peer nodes that are designated to be searching nodes, referred to herein as Search Facilitators (SFs) 2, 3, 4, 5.

Consider the example in which the peer node 1 wishes to find contact information for John Smith. Unless peer node 1 formulates a request that matches entirely an entry in a DHT, then peer node 1 will be unable to find the contact information for John Smith.

A SF 2 is used to store Bloom filters derived from data stored at other peer nodes. In this case, one or more of the SFs stores one or more Bloom filters that relate to the contact details for John Smith.

The peer node 1 uses a tag based search to query a SF 2. In this case, we assume that the data relating to John Smith has certain parameters or tags along the lines of [SIP URI: john.smith@work.com; Name: Smith, John; Address:; Phone: +331234567; Email: john.smith@yahoo.fi; Type: person, Company: Firm, . . . ]

The peer node that stores the contact information creates a Bloom filter with the parameters shown above. Alternatively, the SF creates the Bloom filter. The Bloom filter is then stored in the SF. Note that the Bloom filter can be created manually or automatically. Storing a Bloom filter at the SF is far more space efficient than storing a record of all of the data at the SF, thereby saving storage space. The Bloom filters stored at the SF are used when a peer node wishes to perform a search for data without having all of the information required to perform a DHT search.

In this example, peer node 1 only has partial information relating to John Smith. In this case, the only information that peer node 1 has is the name of John Smith and the type of contact (person). Peer node 1 therefore calculates a Bloom filter for the known information, and decides on a SF to send the Bloom filter to. A request message is then sent in step S1 to the SF 2, the query message including the generated Bloom filter. The SF 2 compares the received Bloom filter with Bloom filters stored in its memory, and if a positive match is found with a Bloom filter stored at the SF 2, the SF replies with the identity of the node associated with the stored Bloom filter. This allows the peer node 1 to obtain the information from the peer node that has the required information.

While SF 2 could reply straight away with a list of suitable matches for the Bloom filters, the request may be forwarded to further SFs as a better match may be found. In the example shown in FIG. 1, SF 2 forwards the request to a second SF 3 in step S2. This process is repeated in steps S3 and S4 and the request is forwarded to SFs 4 and 5. Finally a reply is sent in step S5 from SF 5 to the peer node 1. The reply includes all of the most likely matches, and can then query the identified peer nodes in order to obtain the required information.

Note that this embodiment describes the request being sent sequentially to each SF; in an alternative embodiment the peer node 1 could send the request to each SF. This may be done so that all requests are sent at approximately the same time, or alternatively the peer node 1 could send a request to each SF sequentially, sending a request to a SF only after it has received a reply from another SF. In either case, the peer node will receive a reply from each SF.

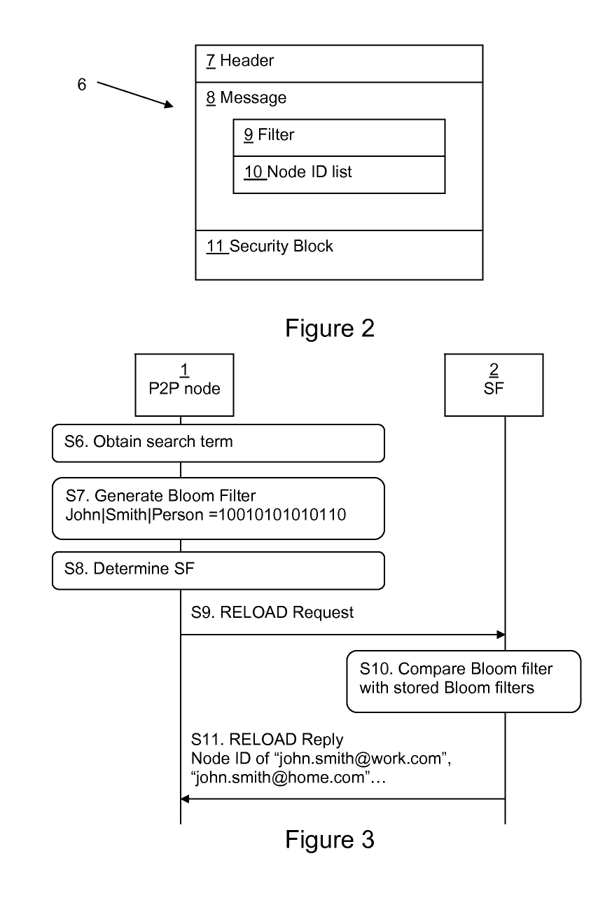

In an embodiment of the invention, SF 1 is a node in a RELOAD overlay network. In this case, the query message is sent in the form of a request, and has the message structure shown in FIG. 2. The message 6 has a header 7, and message content 8 which includes the search filter 9. A security block 11 is also present. A reply message has the same structure as a request message, and also includes a Node ID list 10.

The Search Facilitator 2, upon receiving the request message, compares the Bloom filter of the payload with the Bloom filters it has stored. If there are different filters that are a superset of the stored bloom filter (i.e. a high percentage of bits match) the Search Facilitator 2 replies with the NodeIDs of the peers that match the filter.

FIG. 1 shows that the routing in the overlay network is recursive, and the message is sent to more than one SF, but other alternatives are also feasible. For example, the SF 2 may reply directly to the peer node 1 with a reply rather than sending the request message to other SFs.

Referring to FIG. 3, the signalling according to the above embodiment is illustrated. The following numbering corresponds to FIG. 3:
S6. Peer node 1 obtains a search term. This may be, for example, generated for an automated search or entered by a user.
S7. Peer node 1 wishes to search for contact information for John Smith, and so generates a Bloom filter using the terms “John”, “Smith”, and “Person”.
S8. Peer node 1 determines an SF to send the Bloom filter to in a RELOAD request, and determines that the RELOAD request is to be sent to SF 2. This determination is made using a service discover mechanism, an example of which is ReDiR.
S9. A RELOAD request that includes the generated Bloom filter is sent to SF 2
S10. The SF 2 compares the Bloom filter in the request with stored Bloom filters, and determines a list of Node IDs that have the information according to the stored Bloom filters. Note that this information may contain some false positive results, but cannot contain false negative results.
S11. SF 2 sends a RELOAD reply to peer node 1 that includes the Node ID for the node that has the contact information for John Smith. Alternatively, the request may be forwarded to another SF in the overlay network.

The above example assumes that the RELOAD protocol is used, but it will be appreciated that similar signalling could be carried by messages that use other protocols such as the Peer-to-Peer Protocol (P2PP) or a proprietary protocol.

In order for a SF 2 to function effectively, it must obtain Bloom filters relating to data held by other peer nodes in the P2P network. Other peer nodes store Bloom filters representing data to which they have access, and these Bloom filters are sent to at least one SF

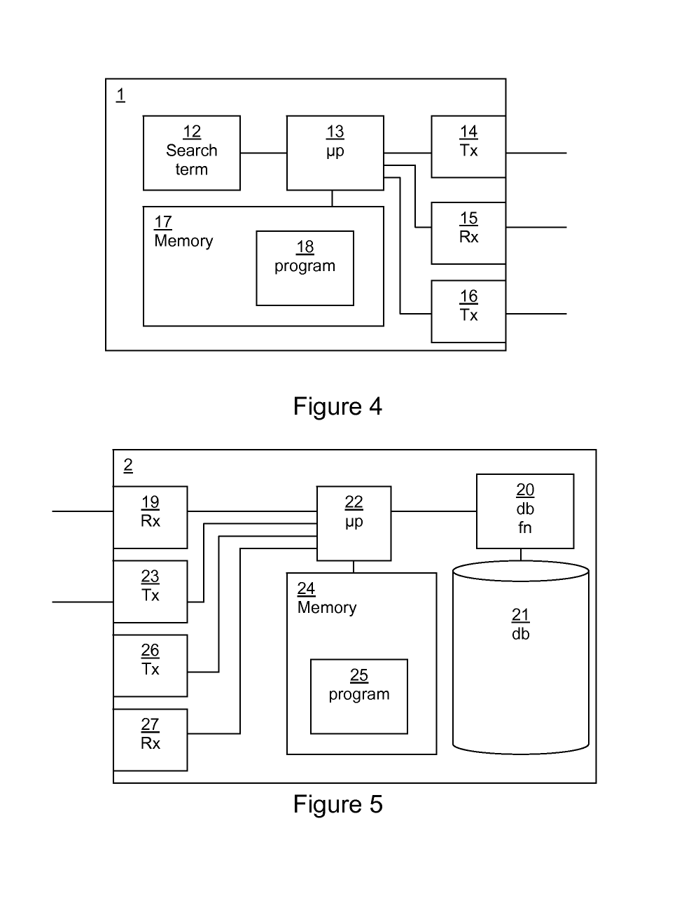

Turning now to FIG. 4, there is shown a peer node 1. The peer node 1 is provided with a device 12 for obtaining a search term. This may be, for example, a data input device such as a keyboard, a mouse, a touch-screen and so on. This allows the user of the peer node 1 to enter a search term. Alternatively, the device 12 may be a processor that generates a search term automatically as part of an automated search. A processor 13 is provided that is arranged to use the search term to generate a Bloom filter. A first transmitter 14 is arranged to send the Bloom filter to a SF 2. A first receiver 15 is arranged to receive, from the SF or another SF, an identity of the further node in the P2P network that has access to data corresponding to the search term and identified by a further Bloom filter that corresponds to the Bloom filter. A second transmitter 16 is also provided for sending to the further node a request for the data.

In a further embodiment, the peer node 1 is provided with a computer readable medium in the form of a memory 17. A computer program 18 may be stored on the memory 17. When the computer program is executed by a processor, it causes the peer node 1 to behave as described above.

FIG. 5 illustrates a SF 2. The SF 2 is provided with a receiver 19 for receiving a message from peer node 1, the message including the Bloom filter generated from a search term. A database accessing function 20 is provided for querying a database 21. Note that the database 21 may be located locally at the SF or remotely at a separate location. In the example shown in FIG. 4, it is located at the SF 2. The database is populated with Bloom filters obtained from other peer nodes, each Bloom filter being associated with an identity of the peer node from which it was obtained.

A processor 22 is provided for determining whether the Bloom filter received from the peer node 1 matches any Bloom filters stored in the database 21. If so, then a transmitter 23 sends an identity of the further node to the peer node 1.

In a further embodiment, the SF 2 is provided with a computer readable medium in the form of a memory 24. A computer program 25 may be stored on the memory 24. When the computer program is executed by a processor, it causes the SF 2 to behave as described above.

Where the SF 2 obtains Bloom filters for populating the database 21 from further P2P nodes, it is provided with a second receiver 27 for receiving from other peer nodes a message that contains at least one Bloom filter. The processor 22 can then use the received information to populate the database 21 with the Bloom filter and the associated node from which the Bloom filter was received.

The SF 2 may be implemented as a separate node or, for example, as a server component on a DHT peer.

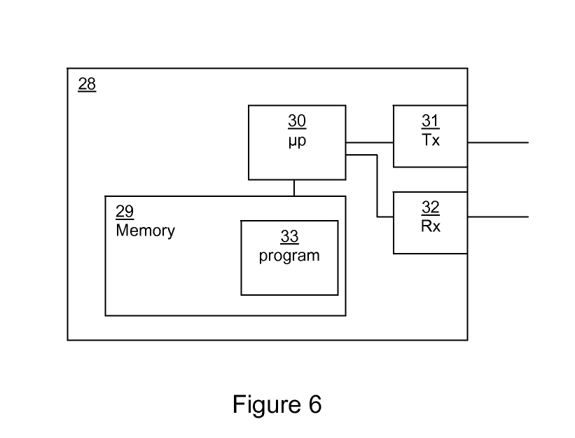

In order to populate the database 21, each SF must receive Bloom filters from other nodes in the P2P network. FIG. 6 illustrates such a node 28. The node 28 is provided with a computer readable medium in the form of a memory 29 for storing data. A processor 30 generates a Bloom filter using at least part of the stored data and uses a transmitter 31 to send the Bloom filter and an identity of the node to the SF 2. This allows the SF to use the Bloom filter and the identity of the node in a search for data. A receiver 32 may also be provided to receive a request for Bloom filters from the SF 2.

In a further embodiment, a computer program 33 is stored on the memory 29 or at a different memory. When the computer program 33 is executed by a processor, it causes the node 26 to behave as described above.

Embodiments herein allow a peer node 1 to search for content, which can be any type of data, even if the content does not fully match the search term. By using an SF that provides a list of nodes and the likelihood that they have the requested data, the embodiments also provide a way for the requesting peer node to obtain the data. The above description uses the RELOAD protocol as an exemplary protocol, but it will be appreciated that any suitable protocol may be used.

By way of example, a user searching for a particular movie in the P2P network would heretofore need to know exact data for that movie, including for example the name of the movie and so on. According to embodiments herein, by contrast, the user can formulate a less exact search term and still find the movie. In this case, a Bloom filter relating to the movie and stored in the SF 2 may have been created by hashing the values [Title: Olympics 2010, Bitrate: 162 bps, Length: 200 minutes, Size: 700 MB, Format: avi, Type: Movie, Genre: Sports, Year: 2010, . . . ]. A peer node 1 looking for the movie, but not knowing the exact title, could use the search terms “movie sports 2010”. A Bloom filter is created by hashing these terms, and will have a positive match with the Bloom filter stored at the SF 2. The SF 2 responds with the identity of the node associated with the stored Bloom filter, and the peer node 1 can request the movie directly from that node.

In alternative embodiments, the SF may forward the request directly to a node that has stores the data, allowing the node to provide the data directly to the requesting peer node 1 without the peer node 1 having to make a separate request.

It will be appreciated by the person of skill in the art that various modifications may be made to the above described embodiments without departing from the scope of the present invention as defined in the appended claims.

What is claimed is:

1. A requesting node for use in a structured peer-to-peer network, the requesting node comprising:
a device configured to obtain a search term;
a processor configured to generate a Bloom filter using the search term;
a first transmitter configured to transmit the Bloom filter to a searching node;
a first receiver configured to receive from the searching node an identity of a further node in the structured peer-to-peer network, the further node having access to data identified by a further Bloom filter that corresponds to the Bloom filter; and
a second transmitter configured to send a request for the data to the further node.

2. The requesting node according to claim 1, wherein said device comprises either a user input device configured to accept a search term entered by a user, or a processor configured to generate the search term.

3. The requesting node according to claim 1, wherein the first transmitter is configured to send the Bloom filter to the searching node in a Resource Location and Discovery (RELOAD) request message.

4. A searching node for use in a structured peer-to-peer network, the searching node comprising:
a receiver configured to receive from a requesting node a message that comprises a Bloom filter generated from a search term;
a database accessing function configured to query a database for at least one further Bloom filter, the at least one further Bloom filter associated with a further peer node in the structured peer-to-peer network;
a processor configured to determine whether the received Bloom filter and the at least one further Bloom filter match; and
a transmitter configured, if the received Bloom filter and the at least one further Bloom filter match, to send an identity of the further peer node towards the requesting node.

5. The searching node according to claim 4, further comprising a second receiver configured to receive the at least one further Bloom filter from the at least one further peer node, and wherein the processor is further configured to populate the database with the at least one further Bloom filter and to associate the at least one further Bloom filter with the identity of the further peer node.

6. The searching node according to claim 4, wherein the transmitter is configured to forward the Bloom filter to a further searching node.

7. The searching node according to claim 4, wherein the receiver is configured to receive the Bloom filter in a RELOAD request message.

8. A peer node for use in a structured peer-to-peer network, the peer node comprising:
a memory configured to store data shared with the structured peer-to-peer network;
a processor configured to generate a Bloom filter using at least part of the stored data; and
a transmitter configured to send the Bloom filter and an identity of the peer node to a searching node that searches for data with the Bloom filter and identity.

9. A method of searching a structured Peer-to-peer network, the method comprising:
obtaining a search term at a requesting node;
generating a Bloom filter at the requesting node using the search term;
sending the Bloom filter from the requesting node to a searching node;
comparing at the searching node the received Bloom filter with at least one further Bloom filter, the at least one further Bloom filter being stored at a database accessible by the searching node and being associated with a further peer node in the Peer-to-peer network; and
sending an identity of the further peer node towards the requesting node, if according to said comparing the Bloom filter and the further Bloom filter match.

10. The method according to claim 9, further comprising:
receiving the further Bloom filter from the further peer node, the further Bloom filter having been generated using data accessible by the further peer node; and
storing the further Bloom filter and an associated identity of the further peer node in the database.

11. The method according to claim 9, wherein sending the Bloom filter from the requesting node to the searching node comprises sending a request that include the Bloom filter, and wherein the method further comprises, after said comparing, sending the request to a further searching node.

12. The method according to claim 11, further comprising adding results of said comparison to the request before sending the request to the further searching node.

13. The method according to claim 9, wherein sending the Bloom filter from the requesting node to the searching node comprises sending the Bloom filter in a RELOAD request message.

14. A computer program product stored on a computer readable medium and comprising computer readable code which, when run on a requesting node in a structured peer-to-peer network, causes the requesting node to:
obtain a search term;
generate a Bloom filter using the search term;
transmit the Bloom filter to a searching node;
receive from the searching node an identity of a further node in the structured peer-to-peer network, the further node having access to data identified by a further Bloom filter that corresponds to the Bloom filter; and
send a request for the data to the further node.

15. A computer program product stored on a computer readable medium and comprising computer readable code which, when run on a searching node in a structured peer-to-peer network, causes the searching node to:
receive from a requesting node a message that comprises a Bloom filter generated from a search term;
query a database for at least one further Bloom filter that is associated with a further peer node in the structured peer-to-peer network;
determine whether the received Bloom filter and the at least one further Bloom filter match; and
send an identity of the further peer node towards the requesting node if the received Bloom filter and the at least one further Bloom filter match.

16. A computer program product stored on a computer readable medium and comprising computer readable code which, when run on a peer node in a structured peer-to-peer network, causes the peer node to:
store data shared with the structured peer-to-peer network;
generate a Bloom filter using at least part of the stored data; and
send the Bloom filter and an identity of the peer node to a searching node that searches for data with the Bloom filter and identity.

17. A method implemented by a requesting node in a structured peer-to-peer network, the method comprising:
obtaining a search term;
generating a Bloom filter using the search term;
transmitting the Bloom filter to a searching node;
receiving from the searching node an identity of a further node in the structured peer-to-peer network, the further node having access to data identified by a further Bloom filter that corresponds to the Bloom filter; and
sending a request for the data to the further node.

18. The method according to claim 17, wherein transmitting the Bloom filter to a searching node comprises sending the Bloom filter in a RELOAD request message.

19. A method implemented by a searching node in a structured peer-to-peer network, the method comprising:
receiving from a requesting node a message that comprises a Bloom filter generated from a search term;
querying a database for at least one further Bloom filter that is associated with a further peer node in the structured peer-to-peer network;
determining whether the received Bloom filter and the at least one further Bloom filter match; and
sending an identity of the further peer node towards the requesting node if the received Bloom filter and the at least one further Bloom filter match.

20. The method according to claim 19, further comprising:
receiving the further Bloom filter from the further peer node, the further Bloom filter having been generated using data accessible by the further peer node; and
storing the further Bloom filter and an associated identity of the further peer node in the database.
